(19) United States
(12) Patent Application Publication
(10) Pub. No.: US 2009/0208750 A1
(43) Pub. Date: Aug. 20, 2009

(54) Treatment of Mineral Processing Waste Waters Using Disc-Nozzle Centrifuges

(75) Inventors: Milton Costantin, Barcarena (BR); Jose Messias, Barcarena (BR)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Imerys Pigments, Inc.

(21) Appl. No.: 12/370,797

(22) Filed: Feb. 13, 2009

Related U.S. Application Data
(60) Provisional application No. 61/028,799, filed on Feb. 14, 2008.

(51) Int. Cl. C01B 33/26; C02F 1/00; B01D 21/26; B01D 21/01; B32B 5/16

(52) U.S. Cl. 428/402; 210/781; 210/702; 423/328.1

(57) ABSTRACT

Disclosed herein are methods for treating waste waters resulting from mineral processing, including waste water from flushing high intensity magnetic matrices during kaolin processing, by sedimenting the waste water and then subjecting the waste water supernatant from sedimentation to processing in a disc-nozzle centrifuge. Also disclosed herein are methods for further processing of the products of the disc-nozzle centrifugation.

### RELATED APPLICATION

This application claims the benefit of priority under 35 U.S.C. §119(e) of U.S. Provisional Application No. 61/028,799, filed Feb. 14, 2008, the disclosure of which is incorporated herein by reference

### DESCRIPTION OF THE INVENTION

1. Field of the Invention

Disclosed herein are methods for treating impound water from mineral processing. Also disclosed herein are methods of using disc-nozzle centrifuges to clarify mineral processing waste water.

2. Background of the Invention

The present disclosure generally relates to processing impound or waste water resulting from or produced by various mineral processing activities.

Kaolin is generally known as a white inorganic pigment existing naturally as and obtained from kaolin clay. Large deposits of kaolin clay exist in Brazil (e.g., in Rio Capim), in England (e.g., in Devon and Cornwall), in the United States (e.g., in Georgia and South Carolina), in Australia, and in several other countries. Kaolin clay, also referred to as china clay or hydrous kaolin, predominately comprises the mineral kaolinite (Al₂Si₂O₅(OH)₄), anhydrous aluminum silicate, and small amounts of various impurities, such as iron and/or titanium-based impurities. Iron impurities generally discolor the kaolin clay and/or reduce its brightness. Crude kaolin clays are often refined to improve characteristics of the kaolin pigment, such as brightness, opacity, and abrasiveness. During kaolin pigment processing, the kaolin may be subjected to one or more beneficiation steps to remove undesirable impurities, including, for example, magnetic separation, chemical leaching, froth flotation, selective flocculation, and ozone bleaching.

In particular, kaolin clays that contain iron and/or titanium-based impurities (as well as other magnetic impurities) may be subjected to magnetic separation, which generally comprises passing a kaolin suspension (as a slurry) through a high intensity magnetic matrix. One example of such separation is disclosed in U.S. Pat. No. 5,522,924. The magnetic impurities retained in the matrix after separation may be removed with a high pressure, rapid flow stream of water (hereinafter “magnet flush water”). This flushing step regenerates the magnet. The magnet flush water often contains impurities obtained from the kaolin and is generally neutral to weakly alkaline.

Other processes of mineral recovery from clays or raw mined rock, including for example kaolin clays, often create large amounts of dilute aqueous waste waters. As a further example, kaolin processing from primary and sedimentary deposits often creates large amounts of such waste water. The turbidity and/or pH of these waste materials are such that they sometimes cannot be discharged into natural drainage facilities (e.g., natural streams, bodies of water, or public sewage systems) without further treatment and/or clarification. Although some clarified streams from filtration steps may be reused in kaolin processing, the magnet flush water sometimes is not reused because perceptible volumes of chemicals (such as expensive flocculants) might be used to adjust the pH and/or clarify the water.

The magnet flush water and other aqueous waste from kaolin or rock processing may be impounded into lagoons or other structures of fixed capacity. Although the loop of some impoundments may be closed, the volume of the material in the impoundment may continue to rise due to rainfall, plant wash water, pump sealing water, and the like.

The aqueous waste may contain valuable minerals, such as kaolin, in which case it would be desirable to treat or otherwise process the waste in an attempt to extract and recover those minerals. Moreover, it may be desirable to recycle, treat, or otherwise process the waste in order to increase the lifetime of the impoundment.

Previous methods of clarifying waste waters have been investigated. The effectiveness of the method used may depend on the properties of the impounded material. The impound water from the Rio Capim Kaolin (RCC) deposit is generally milky and has an about neutral pH. The neutral pH may help to achieve a compacted, settled impound material, which comprises approximately 70% solid material. At neutral pH, the lifetime of the impounds is also generally increased.

For example, clarification of the RCC impound water has previously been accomplished either by placing the water in a separate impoundment, when available, or by clarifying the impound water in the original impoundment by reducing the pH to from 4 to 5 using sulfuric acid. U.S. Pat. No. 6,077,441, for example, appears to describe the use of separate impoundments to separate mineral waste in conjunction with the use of flocculants to accelerate sedimentation. However, at low pH the low solids generally do not settle well, leaving from 15 to 20% solids in the liquid fraction. Moreover, the addition of large volumes of acid or other liquids may reduce the lifetime of the impoundment and may be costly. Accordingly, a need remains for methods, that are both cost effective and efficient, to treat impound water from mineral processing so that it may be reused or reintroduced into the natural environment.

Disc-nozzle centrifuges have a higher capacity than many other types of centrifuges. In the late 1980s, disc-nozzle centrifuges were generally used in Georgia for fine particle kaolin classification, in a process sometimes termed “desliming” by which the particles are cut at 0.3 microns. Disc-nozzle centrifuges have also been used in Canada for recovering oil from tar sands, which has driven the design of disc-nozzle centrifuges for improved wear protection. Disc-nozzle centrifuges have also been used in other stages of kaolin processing, including classification, defining, dewatering, and desalination. For example, U.S. Pat. No. 5,168,083 appears to disclose the use of disc-nozzle centrifuges for defining kaolin, wherein a low iron content, degritted kaolin clay slurry is dispersed and diluted to a low solids content, and then fractionated in the disc-nozzle centrifuge.

Although disc-nozzle centrifuges have been used in wastewater treatment, traditionally this use has been confined to clarification processes that either do not treat water containing higher levels of impurities, such as magnet flush water, or do not produce an environmentally friendly liquid fraction. No processes or methods to date have used disc-nozzle centrifuges for the direct treatment of pre-sedimented waste water, such as impound water or magnet flush water, containing higher levels of impurities, to produce an environmentally friendly liquid fraction.

Accordingly, it is one object of the present disclosure to clarify magnet flush water or other mineral processing waste water for re-use and/or for discharge into natural drainage. In particular, the present inventors surprisingly found that disc-nozzle centrifuges may be used to treat waste water sedimented at neutral or weakly alkaline pH, without the addition of costly additives, to produce two useful fractions: a coarse fraction and a liquid fraction. The coarse fraction may comprise kaolin of appropriate particle size and/or low enough in magnetic contaminants such that it may be reintroduced into kaolin production processes as semi-processed feed or further processed as a kaolin pigment. The liquid fraction may be directly discharged into natural drainage in compliance with environmental regulations, or may be reused in mineral production processes as magnet flush water or as diluent for slurry streams.

### SUMMARY OF THE INVENTION

Disclosed herein are methods for treating at least one waste water by, in one embodiment, sedimenting the impound water at neutral or weakly alkaline pH and then centrifuging the impound water with a disc-nozzle centrifuge. Also disclosed herein are the products of the disclosed method comprising, in one embodiment, a coarse fraction comprising kaolin dewatered to from about 20% to about 30% solids with a particle size distribution ranging from about 80% to about 97% less than 2 microns, and a liquid fraction with low turbidity and about neutral to weakly alkaline pH.

Also disclosed herein is a water stream possessing a turbidity less than about 40 NTU and a pH ranging from about 5 to about 9, prepared by, in one embodiment, a process comprising the steps of: subjecting at least one waste water from mineral processing to at least one sedimentation step, to create at least one solid suspension fraction; subjecting the at least one solid suspension fraction to at least one centrifugation step comprising use of at least one disc-nozzle centrifuge, to create at least one liquid fraction; and collecting the at least one liquid fraction to form the water stream.

Also disclosed herein is a method for treating waste water from mineral processing by, in one embodiment, subjecting at least one waste water comprising kaolin particles to at least one sedimentation step, to create at least one solid suspension fraction; and subjecting the at least one solid suspension fraction to at least one centrifugation step comprising use of at least one disc-nozzle centrifuge, to create at least one liquid fraction and at least one coarse fraction, wherein the at least one liquid fraction has a turbidity less than about 40 NTU and the at least one coarse fraction comprises kaolin having a particle size from about 80% to about 97% less than 2 microns.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURE

FIG. 1 depicts a process schematic of one embodiment of the methods for treating at least one waste water disclosed herein.

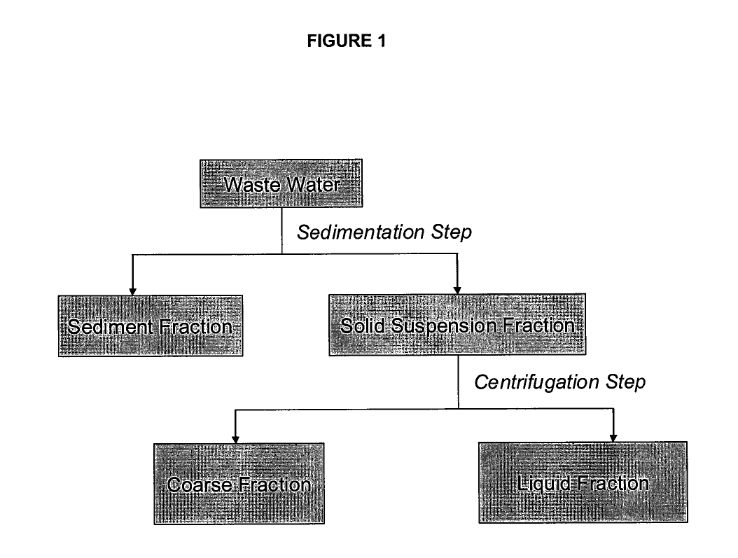

### DESCRIPTION OF THE EMBODIMENTS

Reference will now be made in detail to certain disclosed embodiments of the present inventions. In one embodiment, at least one waste water from mineral processing is sedimented at a neutral or weakly alkaline pH to remove coarse or high specific gravity particles, and then the solid suspension fraction from the sedimentation is processed with a disc-nozzle centrifuge.

The at least one waste water to be processed according to the present inventions may come from any mineral processing source. In one embodiment, the at least one waste water is from one or more kaolin processing steps. In another embodiment, the at least one waste water is from one or more rock processing steps. In a further embodiment, the at least one waste water is from one or more processing steps of kaolin from the Rio Capim area of Brazil. In one embodiment, the waste water comprises impound water. In another embodiment, the waste water comprises magnet flush water. In a further embodiment, the waste water comprises waste from meteoric precipitation.

The at least one waste water may have various chemical and physical characteristics. In one embodiment, the at least one waste water has a pH from about 7 to about 8. In another embodiment, the at least one waste water is from about 3% to about 13% solids. In a further embodiment, the at least one waste water is from about 3% to about 10% solids. In another embodiment, the at least one waste water is about 5% solids. In a further embodiment, the at least one waste water is from about 55 to about 75% ISO brightness. In yet another embodiment, the at least one waste water is from about 60 to about 75% ISO brightness. In yet a further embodiment, the at least one waste water is from about 70 to about 75% ISO brightness. In still another embodiment, the at least one waste water comprises particles such that about 80 to about 90% of the particles have an equivalent spherical diameter less than 2 microns.

The at least one waste water is subjected to at least one sedimentation step. In general, the at least one sedimentation step allows larger particles to settle to the bottom of the at least one waste water, and of those larger particles those with higher molecular weights and/or higher specific gravity may settle faster than those with lower molecular weights and/or lower specific gravity; smaller particles (e.g., those with lower molecular weight and/or lower specific gravity than the larger particles) and/or colloidal particles remain suspended or may settle at a slower rate than larger particles. In one embodiment, the sedimentation step comprises use of an impound lagoon. In another embodiment, the sedimentation step comprises allowing solids in the waste waters to settle in any structure of generally fixed capacity (such as a holding tank). In a further embodiment, the sedimentation step comprises use of more than one impound lagoon and/or structure of generally fixed capacity.

The sedimentation step may also comprise at least one sedimentation additive. Appropriate additives include at least those now known to the skilled artisan or hereafter discovered to assist in the sedimentation of the waste waters and/or improve the characteristics of the coarse and/or liquid fraction. In one embodiment, the sedimentation step comprises at least one thickener. In another embodiment, the sedimentation step comprises at least one coagulant. In one embodiment, the at least one coagulant is polymeric. In another embodiment, the at least one coagulant is chosen from quaternary polyamines, poly DADMAC, and dicyandiamide resins. In yet another embodiment, the at least one coagulant is inorganic, such as, for example, alum, and can be used alone or in conjunction with at least one anionic or cationic polymer. In a further embodiment, the sedimentation step comprises at least one flocculant. In one embodiment, the at least one flocculant is a flocculation polymer. In another embodiment, the at least one flocculant is an anionic flocculation polymer having a molecular weight greater than about one million. In a further embodiment, the at least one flocculation polymer is an anionic flocculation polymer having a molecular weight ranging from about 10 to about 15 million. An exemplary anionic flocculation polymer includes, but is not limited to, a copolymer of a polyacrylamide and a polyampholyte. In yet another embodiment, the at least one flocculation polymer is a cationic polymer, including but not limited to polyamine, poly-dadmac, or poly-guanidine. In yet a further embodiment, the at least one flocculation polymer is non-ionic, including but not limited to polyacrylamides. In still another embodiment, the at least one flocculation polymer is chosen from acrylate-acrylamide copolymers. The waste waters may be subjected to the at least one flocculant in at least one flocculation process step, which may comprise at least one of ozoning, leaching, bleaching, filtering, re-dispersing in a makedown tank, and spray drying. Exemplary flocculation processes may be found in U.S. Pat. Nos. 4,227,920 and 5,685,900.

After the at least one sedimentation step, the sedimented at least one waste water comprises at least one solid suspension fraction and at least one sediment fraction.

The at least one solid suspension fraction is then subjected to at least one centrifugation step. In one embodiment, the at least one centrifugation step comprises the use of at least one disc-nozzle centrifuge. In another embodiment, the at least one centrifugation step comprises the use of at least one solid bowl decanter centrifuge. In another embodiment the at least one centrifugation step comprises the use of at least two centrifuges used in series, for example the use of at least one solid bowl decanter centrifuge followed by or following the use of at least one disc-nozzle centrifuge. One appropriate disc-nozzle centrifuge includes, but is not limited to, the Westfalia DC 260. The at least one centrifugation step may comprise the addition of at least one centrifugation additive. In one embodiment, the at least one centrifugation additive is a coagulant. In another embodiment, the at least one centrifugation additive is a flocculant. In a further embodiment, the at least one coagulant or at least one flocculant as at least one centrifugation additive is chosen from those discussed herein in regards to at least one sedimentation additive as, respectively, at least one coagulant or at least one flocculant. The at least one centrifugation step produces at least one coarse fraction and at least one liquid fraction.

In one embodiment, the at least one liquid fraction has a turbidity less than about 40 NTU (nephelometric turbidity units). In another embodiment, the turbidity is less than about 25 NTU. In a further embodiment, the turbidity is less than about 5 NTU. In still another embodiment, the turbidity is less than about 1 NTU. In yet another embodiment, the turbidity is from about 0.1 NTU to about 100 NTU. In yet a further embodiment, the turbidity is less than about 100 ppm. In still another embodiment, the turbidity is from about 1 ppm to about 100 ppm. Turbidity may, for example, be measured by nephelometry according to the method described in James O'Dell, EPA Office of Research and Development, “Method 180.1, Determination of Turbidity by Nephelometry,” August 1993 (Revision 2.0). Other appropriate methods for determining turbidity may also by specified, for example, by various National or State environmental regulatory bodies.

In another embodiment, the at least one liquid fraction has a pH from about 5 to about 9. In a further embodiment, the at least one liquid fraction has a pH of about 7. In yet another embodiment, the at least one liquid fraction has a turbidity and/or pH such that it can be discharged directly into natural drainage without further processing and in compliance with appropriate environmental regulations. In yet a further embodiment, the at least one liquid fraction has a turbidity and/or pH such that can be used as process water during various mineral processing steps for dilution of slurry streams or used as magnet flush water. In still another embodiment, the at least one liquid fraction is lower in magnetic contaminants than the sediment fraction.

The at least one coarse fraction comprises solids. In one embodiment, the at least one coarse fraction comprises kaolin. The at least one coarse fraction solids may have various sizes of particles, as discussed in greater detail below. In yet another embodiment, the at least one coarse fraction is appropriate for use as a semi-processed feed material for coating kaolin production. In yet a further embodiment, the at least one coarse fraction is lower in magnetic contaminants than the sediment fraction. In still another embodiment, the at least one coarse fraction is from about 55% to about 75% ISO brightness. In still a further embodiment, the at least one coarse fraction comprises kaolin useful for paper coating.

ISO Brightness is a measure of the diffuse reflectance using, for example, a Diffuse/0° Geometry tester. See ISO Standards 2370 and 2469. ISO Brightness is reported as a percentage against the maximum brightness of a standard sample.

As will be appreciated by those skilled in the art, the particle size distribution (psd) of a particular product may be determined by measuring the sedimentation speeds of the dispersed particles of the particulate product through a standard dilute aqueous suspension, e.g., by use of a SEDIGRAPH instrument (such as the SEDIGRAPH 5100) from Micromeritics Instrument Corporation of Norcross, Ga. The size of a given particle may expressed in terms of the diameter of a sphere of equivalent diameter that sediments through the suspension, that is, an equivalent spherical diameter or esd. The SEDIGRAPH instrument records the percentage by weight of particles having an esd less than a particular esd value, versus that esd value. In one embodiment, the at least one coarse fraction has a particle size distribution ranging from about 80% to about 97% less than 2 microns. In another embodiment, the at least one coarse fraction has a particle size distribution ranging from about 80% to about 90% less than 2 microns. In a further embodiment, the at least one coarse fraction comprises solids with a particle size distribution less than about #2, wherein about 85% of the particles have sizes less than about 2 microns. In yet another embodiment, the solids have particle sizes greater than about fine #1, wherein about 95% of the particles have sizes less than 2 microns. In a further embodiment, the solids have particle sizes from about #2 to about fine #1.

The at least one coarse fraction and the at least one liquid fraction may be collected and used as various products or in various processes now known to the skilled artisan or hereafter discovered. In one embodiment, the at least one coarse fraction comprises kaolin and is capable of being used as a kaolin pigment, with or without further processing. In another embodiment, the at least one liquid fraction may be discharged to the environment (such as a lake, stream, river, or public sewage system) with or without further processing. In a further embodiment, the at least one liquid fraction may be used as process water for dilution of slurry stream in mineral processing. In yet another embodiment, the at least one liquid fraction may be used as magnet flush water in a magnetic separation step of mineral processing.

The at least one coarse fraction may be subjected to at least one beneficiation process. Examples of at least one beneficiation step include, but are not limited to, magnetic separation, filtration, chemical leaching or bleaching, froth flotation, selective flocculation, and ozone bleaching. The at least one coarse fraction may also be processed to produce a coating kaolin.

In one embodiment, the at least one coarse fraction is passed as a suspension through a high intensity magnetic separator. Appropriate high intensity magnetic separators include those now known to the skilled artisan and those that may be hereafter discovered. In one embodiment, magnetic separation results in a brightness of about 86 ISO. In another embodiment, magnetic separation results in a brightness gain of about 11 to about 16 ISO. In a further embodiment, magnetic separation results in a particle size distribution ranging from about 70% to about 92% less than 2 microns.

In one embodiment, the at least one coarse fraction may be subjected to at least one bleaching step. Chemical bleaching may be performed, for example, with at least one reductive bleaching agent. Exemplary bleaching agents include, but are not limited to, hydrosulfite, formamidine sulphinic acid, sodium borohydride, and sodium bisulfite. In one embodiment, the bleaching agent is added in a dose ranging from about 0.5 to about 6 pounds per ton. In another embodiment, the bleaching agent is added in a dose ranging from about 0.5 to about 4 pounds per ton. In a further embodiment, the dose ranges from about 5 to about 6 pounds per ton. In yet another embodiment, the bleached material has a brightness of about 89 ISO. In yet a further embodiment, the bleached material has a brightness gain of about 2 to about 5 ISO over a coarse fraction subjected to magnetic separation.

Unless otherwise indicated to the contrary, all numbers expressing quantities of ingredients, reaction conditions, and so forth used in the specification, including claims, are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting for the broad scope of the invention are approximations, unless otherwise indicated the numerical values set forth in the specific examples are reported as precisely as possible. Any numerical value, however, inherently contains certain errors necessarily resulting from the standard deviation found in their respective testing measurements. The section headings used in this disclosure are provided merely for the convenience of the reader and are not intended to limit the scope of the inventions described herein.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for treating waste water from mineral processing comprising:
a. subjecting at least one waste water comprising kaolin particles to at least one sedimentation step, to create at least one solid suspension fraction;
b. subjecting the at least one solid suspension fraction to at least one centrifugation step comprising use of at least one disc-nozzle centrifuge, to create at least one liquid fraction and at least one coarse fraction,
wherein the at least one liquid fraction has a turbidity less than about 5 NTU and the at least one coarse fraction comprises kaolin having a particle size from about 80% to about 97% less than 2 microns.

2. The method of claim 1, wherein the at least one sedimentation step occurs by use of an impound lagoon.

3. The method of claim 1, wherein the at least one sedimentation step comprises at least one sedimentation additive.

4. The method of claim 3, wherein the at least one sedimentation additive is chosen from the group consisting of thickeners, coagulants, and flocculants.

5. The method of claim 1, wherein the at least one waste water is at least one of magnet flush water and waste from meteoric precipitation.

6. The method of claim 1, wherein the at least one coarse fraction has an ISO brightness from about 55% to about 75%.

7. The method of claim 1, wherein the at least one coarse fraction comprises from about 20% to about 30% solids.

8. The method of claim 1, wherein the at least one liquid fraction has a pH ranging from about 5 to about 9, for example, about 7.

9. The method of claim 1, wherein the at least one liquid fraction has a solids content ranging from about 3% to about 13%.

10. A kaolin pigment possessing an ISO brightness of greater than about 55%, prepared by a process comprising the steps of:
a. subjecting at least one waste water comprising kaolin particles to at least one sedimentation step, to create at least one solid suspension fraction;
b. subjecting the at least one solid suspension fraction to at least one centrifugation step comprising use of at least one disc-nozzle centrifuge, to create at least one coarse fraction; and,
c. collecting the at least one coarse fraction to form the kaolin pigment product.

11. The kaolin pigment of claim 10, wherein the pigment comprises kaolin having a particle size from about 80% to about 97% less than 2 microns.

12. The kaolin pigment of claim 10, wherein the pigment has an ISO brightness of about 70% to about 75%.

13. The kaolin pigment of claim 10, wherein the pigment has an ISO brightness of greater than about 86%.

14. The kaolin pigment of claim 13, wherein the process additionally comprises the step of passing the kaolin pigment product through a high intensity magnetic separator.

15. The kaolin pigment of claim 13, wherein the pigment has an ISO brightness of greater than about 89%.

16. The kaolin pigment of claim 15, wherein the process additionally comprises the step of subjecting the magnetically separated kaolin pigment product to at least one bleaching step.

17. A water stream possessing a turbidity less than about 5 NTU and a pH ranging from about 5 to about 9, prepared by a process comprising the steps of:
a. subjecting at least one waste water from mineral processing to at least one sedimentation step, to create at least one solid suspension fraction;
b. subjecting the at least one solid suspension fraction to at least one centrifugation step comprising use of at least one disc-nozzle centrifuge, to create at least one liquid fraction; and
c. collecting the at least one liquid fraction to form the water stream.

18. The water stream of claim 17, wherein the pH is about 7.

19. Use of the water stream of claim 17 as dilution process water in a kaolin manufacturing process.

20. Use of the water stream of claim 17 as magnet flush water in a kaolin manufacturing process.
